(19) United States
(12) Patent Application Publication
(10) Pub. No.: US 2012/0021177 A1
(43) Pub. Date: Jan. 26, 2012

(54) WATER-REPELLENT SUBSTRATE AND PROCESS FOR ITS PRODUCTION

(75) Inventors: Yohei Kawai, Tokyo (JP); Takashige Yoneda, Tokyo (JP)

(73) Assignee: ASAHI GLASS COMPANY, LIMITED, Tokyo (JP)

(21) Appl. No.: 13/006,955

(22) Filed: Jan. 14, 2011

Related U.S. Application Data
(63) Continuation of application No. PCT/JP09/62634, filed on Jul. 10, 2009.

(30) Foreign Application Priority Data
Jul. 17, 2008 (JP) 2008-186148

(51) Int. Cl. B05D 5/06; B32B 17/06

(52) U.S. Cl. 428/148; 427/165

(57) ABSTRACT

To provide a water-repellent substrate with its surface having a large water contact angle and capable of maintaining the contact angle even against abrasion.

A process for producing a water-repellent substrate, characterized by forming, on at least one side of a substrate, an undercoat layer which comprises the following aggregates (A) of metal oxide fine particles and a metal oxide type binder (provided that the metal oxide type binder is a component formed from a binder material containing a metal compound (B) which can be converted to a metal oxide by hydrolytic condensation or pyrolysis) and which has a concave-convex surface, and then, forming a water-repellent layer on the undercoat layer:

Aggregates (A) of metal oxide fine particles: aggregates which are each composed of metal oxide fine particles having an average primary particle size of from 10 to 80 nm and which have an average aggregate particle size of from 100 to 1200 nm.

### TECHNICAL FIELD

The present invention relates to a water-repellent substrate and a process for its production.

### BACKGROUND ART

When rainwater deposits on a window glass of a transport machine during raining, the driver's visibility tends to be poor, which may hinder the driving. Therefore, it has been attempted to impart water-repellency to the surface of a glass plate so that deposited rainwater may be readily removed. And, in recent years, various attempts to further increase the water repellency to improve the visibility have been proposed. For example, Patent Document 1 discloses that a low reflection film composed of fine silica particles and a binder, is formed on a glass substrate, and its surface is further covered with a water-repellent covering film.

### PRIOR ART

### Patent Document

Patent Document 1: JP-A-2001-278637

### DISCLOSURE OF THE INVENTION

### Problem to be Solved by the Invention

However, the water-repellent glass substrate disclosed in Patent Document 1 was still inadequate to show ultra-water-repellency as the initial water contact angle of its surface was 125°. Here, the ultra-water-repellency in this application means that the initial water contact angle is at least 135°.

### Means to Solve the Problem

The present invention has been made to solve the above problem and provides the following.

[1] A process for producing a water-repellent substrate, characterized by forming, on at least one side of a substrate, an undercoat layer which comprises the following aggregates (A) of metal oxide fine particles and a metal oxide type binder (provided that the metal oxide type binder is a component formed from a binder material containing a metal compound (B) which can be converted to a metal oxide by hydrolytic condensation or pyrolysis) and which has a concave-convex surface, and then, forming a water-repellent layer on the undercoat layer:

Aggregates (A) of metal oxide fine particles: aggregates which are each composed of metal oxide fine particles having an average primary particle size of from 10 to 80 nm and which have an average aggregate particle size of from 100 to 1200 nm.

[2] A water-repellent substrate, characterized by having, on at least one side of a substrate, an undercoat layer which comprises the following aggregates (A) of metal oxide fine particles and a metal oxide type binder (provided that the metal oxide type binder is a component formed from a binder material containing a metal compound (B) which can be converted to a metal oxide by hydrolytic condensation or pyrolysis) and which has a concave-convex surface, and having a water-repellent layer on the undercoat layer:

Aggregates (A) of metal oxide fine particles: aggregates which are each composed of metal oxide fine particles having an average primary particle size of from 10 to 80 nm and which have an average aggregate particle size of from 100 to 1200 nm.

[3] A water-repellent substrate, characterized in that it is obtained by applying, on at least one side of a substrate, a dispersion liquid which comprises the following aggregates (A) of metal oxide fine particles, a binder material containing a metal compound (B) which can be converted to a metal oxide by hydrolytic condensation or pyrolysis and a dispersing medium, followed by drying, to form an undercoat layer which has a concave-convex surface, and then, applying a hydrophobic material on the undercoat layer, followed by drying:

Aggregates (A) of metal oxide fine particles: aggregates which are each composed of metal oxide fine particles having an average primary particle size of from 10 to 80 nm and which have an average aggregate particle size of from 100 to 1200 nm.

### Advantageous Effects of the Invention

The water-repellent substrate of the present invention has a surface having a large water contact angle and is capable of maintaining such a large contact angle even against abrasion.

### BEST MODE FOR CARRYING OUT THE INVENTION

In the present invention, a compound represented by the following formula (1) will be referred to also as a compound (1). The same applies to compounds represented by other formulae.

The water-repellent substrate of the present invention is a substrate obtained by forming, on at least one side of a substrate, an undercoat layer which comprises the following aggregates (A) of metal oxide fine particles and a metal oxide type binder (provided that the metal oxide type binder is a component formed from a binder material containing a metal compound (B) which can be converted to a metal oxide by hydrolytic condensation or pyrolysis) and which has a concave-convex surface, and then, forming a water-repellent layer on the undercoat layer:

Aggregates (A) of metal oxide fine particles: aggregates which are each composed of metal oxide fine particles having an average primary particle size of from 10 to 80 nm and which have an average aggregate particle size of from 100 to 1200 nm.

The substrate in the present invention is preferably a substrate made of glass, metal, ceramics, a resin or a combination thereof (such as a composite material or a laminated material). The material for the resin substrate may be at least one member selected from a polyethylene terephthalate, a polycarbonate, a polymethyl methacrylate, a triacetylcellulose, etc. The substrate may be transparent or opaque and may suitably be selected depending upon the particular application. For example, in a case where the water-repellent substrate of the present invention is used as a window glass for a transport machine such as an automobile, as a window glass for building, or as a cover for a solar cell, it is preferably a transparent glass plate.

The surface of the substrate is preferably polished with a polishing agent made of e.g. cerium oxide or degreased by means of e.g. cleaning with an alcohol. Otherwise, oxygen plasma treatment, corona discharge treatment or ozone treatment may, for example, be applied. The shape of the substrate may be a flat plate, or may entirely or partially have a curvature. The surface of the substrate may be flat or may have a concave-convex structure. The thickness of the substrate is suitably selected depending upon the particular application and is usually preferably from 1 to 10 mm. Further, as a substrate, a resin film having a thickness of from about 25 to 500 μm may be used. The substrate may preliminarily be provided with a coating film made of an inorganic material and/or an organic material to impart at least one function selected from a hard coat, an alkali barrier, coloring, electrical conduction, prevention of static charge, light scattering, antireflection, collection of light, polarization of light, ultraviolet shielding, infrared shielding, antifouling, antifogging, photocatalyst, antibacterial, fluorescent, light storage, wavelength change, control of refractive index, water repellency, oil repellency, removal of finger prints, lubricity, etc.

The water-repellent substrate of the present invention may have an undercoat layer and a water-repellent layer on each side of the substrate, or may have an undercoat layer and a water-repellent layer on one side of the substrate, and selection may suitably be made depending upon the particular application. For example, in a case where the water-repellent substrate of the present invention is to be used for a window glass for a transport machine such as an automobile or for a window glass for building, it is preferably a glass plate having an undercoat layer and a water-repellent layer on one side of the substrate.

Aggregates (A) of metal oxide fine particles (hereinafter sometimes referred to simply as agglomerates (A)) to be used for forming the undercoat layer are aggregates which are each composed of metal oxide fine particles having an average primary particle size of from 10 to 80 nm and which have an average aggregate particle size of from 100 to 1,200 nm. Hereinafter, metal oxide fine particles having an average primary particle size of from 10 to 80 nm constituting the aggregates (A) may also be referred to as metal oxide fine particles (C).

The average primary particle size of the metal oxide fine particles (C) is from 10 to 80 nm, preferably from 15 to 60 nm. When the average primary particle size of the metal oxide fine particles (C) is within the above range, there will be such a merit that the surface area of the film becomes large due to the concave-convex structure derived from the particles, whereby the water repellency will be improved.

Further, the average aggregate particle size of the aggregates (A) is from 100 to 1,200 nm, preferably from 150 to 500 nm. When the average aggregate particle size is at least 100 nm, proper voids will be formed among the aggregate particles when applied on the substrate, whereby when water drops are deposited, ultra-water-repellency can easily be attained including air. When the average aggregate particle size is at most 1,200 nm, the concave-convex structure can be maintained even after the abrasion.

In the present invention, the value of the average primary particle size of the metal oxide fine particles (C) is a value obtained by observing the metal oxide fine particles (C) by a transmission type electron microscope, whereby 100 particles are randomly selected, the particle sizes of the respective metal oxide fine particles (C) are measured, and the particle sizes of the 100 metal oxide fine particles (C) is averaged.

The metal oxide fine particles (C) constituting the aggregates (A) may be fine particles having substantially no internal voids (solid fine particles) or fine particles having internal voids (hollow fine particles). Selection between the solid fine particles and the hollow fine particles may suitably be made depending upon the particular application. For example, in a case where the water-repellent substrate of the present invention is to be used for a window for a vehicle such as an automobile, or a cover for a solar cell, transparency is required for the water-repellent substrate. Accordingly, it is preferred to use hollow fine particles. Further, it is also possible to use solid fine particles and hollow fine particles in combination.

The aggregates (A) of metal oxide fine particles are preferably aggregates of fine particles containing at least one metal oxide selected from the group consisting of SiO₂, Al₂O₃, TiO₂, SnO₂, ZrO₂ and CeO₂, particularly preferably aggregates of fine particles containing SiO₂. That is, the metal oxide fine particles (C) are preferably fine particles containing at least one metal oxide selected from the group consisting of SiO₂, Al₂O₃, TiO₂, SnO₂, ZrO₂ and CeO₂, particularly preferably fine particles containing SiO₂.

Further, as the fine particles, it is also possible to use organic fine particles or inorganic fine particles other than the metal oxide fine particles, but from the viewpoint of weather resistance, fine particles of inorganic substance are preferred. Fine particles of inorganic substance other than metal oxide fine particles may, for example, be a metal fluoride such as MgF₂, a metal sulfide such as ZnS, a metal cerenide such as ZnSe or a metal nitride such as Si₃N₄. However, a metal oxide is still preferred in consideration of the adhesion to the substrate and the chemical stability.

Here, the “fine particles containing a metal oxide” will be described with reference to fine particles containing SiO₂. With respect to the fine particles containing SiO₂, the following cases (i) to (iv) may be mentioned.

(i) A case where the metal oxide fine particles are fine particles which have substantially no internal voids and which are composed substantially solely of SiO₂ (i.e. a case where they are solid fine particles composed substantially solely of SiO₂),

(ii) a case where the metal oxide fine particles are fine particles which have substantially no internal voids and which contain SiO₂ as the main component and further contain a metal oxide other than SiO₂ (i.e. a case where they are solid fine particles which contain SiO₂ as the main component and further contain a metal oxide other than SiO₂),

(iii) a case where the metal oxide fine particles are fine particles which have internal voids, wherein the shell portion is composed substantially solely of SiO₂ (i.e. a case where they are hollow fine particles each having a shell composed substantially of SiO₂),

(iv) a case where the metal oxide fine particles are fine particles which have internal voids, wherein the shell portion contains SiO₂ as the main component and further contains a metal oxide other than SiO₂ (i.e. a case where they are hollow fine particles wherein the shell portion contains SiO₂ as the main component and further contains a metal oxide other than SiO₂).

In the case of the above (ii) and (iv), the metal oxide other than SiO₂ may, for example, be Al₂O₃, TiO₂, SnO₂, ZrO₂, CeO₂, CuO, Cr₂O₃, CoO, Fe₂O₃, MnO₂, NiO, ZnO, etc. SiO₂ and a metal oxide other than SiO₂ may be in a state where they are simply mixed, or they may be present in the form of a composite oxide. Otherwise, they may be core-shell type fine particles wherein the core is made of a metal oxide other than SiO₂ (such as ZnO), and the shell is made of SiO₂.

In the case of the above (iv), the amount of the metal oxide other than SiO₂ contained in the hollow fine particles is from 0.2 to 8.0 parts by mass, preferably from 0.5 to 5.0 parts by mass, per 100 parts by mass of SiO₂ contained in the hollow fine particles. When the amount of other metal (calculated as oxide) is at least 0.2 part by mass, the strength of the hollow fine particles becomes sufficiently high. When the amount of the metal oxide other than SiO₂ is at most 8.0 parts by mass, the refractive index of the hollow fine particles can be controlled to be low.

The amount of the metal oxide other than SiO₂ is, in the case of Al, an amount calculated as Al₂O₃, in the case of Cu, an amount calculated as CuO, in the case of Ce, an amount calculated as CeO₂, in the case of Sn, an amount calculated as SnO₂, in the case of Ti, an amount calculated as TiO₂, in the case of Cr, an amount calculated as Cr₂O₃, in the case of Co, an amount calculated as CoO, in the case of Fe, an amount calculated as Fe₂O₃, in the case of Mn, an amount calculated as MnO₂, in the case of Ni, an amount calculated as NiO, and in the case of Zn, an amount calculated as ZnO.

In the present invention, the metal oxide fine particles (C) may be any of the above (i) to (iv) and may suitably be selected depending upon the particular application.

The shape of the metal oxide fine particles (C) may be any of a spherical shape, a fusiform shape, a rod shape, an amorphous shape, a cylindrical shape, a needle shape, a flat shape, a scale shape, a leaf shape, a tubular shape, a sheet shape, a chain shape and a plate shape, and it is preferably a spherical shape or a rod shape. Here, “spherical shape” means that the aspect ratio is from 1 to 2.

Further, in a case where hollow fine particles are to be used as the metal oxide fine particles (C), the thickness of the shell is preferably from 1 to 10 nm, particularly preferably from 2 to 5 nm. When the thickness of the shell is at least 1 nm, it is possible to obtain an undercoat layer having a sufficient strength. When the thickness of the shell is at most 10 nm, it is possible to control the refractive index of the particles to be low and to form an undercoat layer having high transparency.

The thickness of the shell is a value obtained by observing the metal oxide fine particles (C) by a transmission type electron microscope, whereby 100 particles are randomly selected, the shell thicknesses of the respective metal oxide fine particles (C) are measured, and the shell thicknesses of the 100 metal oxide fine particles (C) are averaged.

In the present invention, the method for producing the aggregates (A) is not particularly limited, and the following methods may be employed.

Method (1): A method of aggregating metal oxide fine particles having a desired average primary particle size to obtain aggregates (A) having a desired aggregate particle size.

Method (2): A method of disintegrating aggregates obtained from metal oxide fine particles having a desired average primary particle size to obtain aggregates (A) having a desired aggregate particle size.

The methods (1) and (2) may be adopted irrespective of solid fine particles or hollow fine particles.

The method (1) may be carried out by adding a substance capable of lowering the surface charge or capable of bonding particles to one another, to a dispersion liquid wherein metal oxide fine particles having a desired average primary particle size are dispersed, followed by heating and aging, as the case requires. And, the aggregate particle size can be adjusted by adjusting the amount of the additive, the heating temperature and the heating time. Usually, the heating temperature is from 30 to 500° C., and the heating time is from one minute to 12 hours. As the additive, a surface charge controlling agent such as an ion exchange resin, potassium nitrate or sodium polyaluminate, or a particle-bonding agent such as sodium silicate or tetraethoxysilane may be used. The amount of the additive is preferably at most 10 mass %, based on the solid content of the metal oxide fine particles.

As the method (2), the following methods are preferred.

Method (2-1): A method of preparing a dispersion liquid having, dispersed in a dispersing medium, metal oxide fine particles having a desired average primary particle size and/or agglomerates of such metal oxide fine particles, then removing the dispersing medium to obtain a solid content, and disintegrating the solid content by means of e.g. a ball mill, a beads mill, a sand mill, a homomixer or a paint shaker.

Method (2-2): A method of producing aggregates (clusters) of core-shell type fine particles having shells made of a metal oxide such as SiO₂, followed by disintegration.

In a case where the aggregates (A) are aggregates composed of hollow fine particles, a step of removing core fine particles is further carried out. The step of removing core fine particles may be carried out before or after the disintegrating step. Further, in a case where core-shell type fine particles are used to obtain aggregates (A) composed of hollow fine particles, such an operation can be carried out with reference to JP-A-2006-335881 or JP-A-2006-335605 by the present applicant.

In the method (2-1), removal of the dispersing medium can be carried out by the following methods.

(a) A method of heating the dispersion liquid of metal oxide fine particles to volatilize the dispersing medium.

(b) A method of subjecting the dispersion liquid of metal oxide fine particles to solid-liquid separation to obtain the solid content.

(c) A method of employing a spray dryer to spray the dispersion liquid of metal oxide fine particles into a heated gas to volatilize the dispersing medium, etc. (spray drying method).

(d) A method of cooling the dispersion liquid of metal oxide fine particles under reduced pressure to sublime the dispersing medium, etc. (freeze drying method).

In the method (2-2), the shape of the core fine particles is not particularly limited. For example, particles of a spherical shape, a fusiform shape, a rod shape, an amorphous shape, a cylindrical shape, a needle shape, a flat shape, a scale shape, a leaf shape, a tubular shape, a sheet shape, a chain shape or a plate shape may be used. Particles having different shapes may be used in combination. Further, if the core fine particles are mono dispersed, aggregate particles tend to be hardly obtainable, and therefore, it is preferred to use flocculates having from 2 to 10 core fine particles flocculated.

The core fine particles are not particularly limited and may be fine particles made of a material which is commonly used for the preparation of core-shall fine particles. For example, in a case where aggregates of hollow fine particles are to be obtained, ones soluble (or decomposable or sublimable) by heat, acid or light are preferably used as the core fine particles. For example, at least one member may be used which is selected from e.g. heat decomposable organic polymer fine particles of e.g. a surfactant micelle, a water-soluble organic polymer, a styrene resin or an acrylic resin; acid-soluble inorganic fine particles of e.g. sodium aluminate, calcium carbonate, basic zinc carbonate or zinc oxide; metal chalcogenide semiconductor particles of e.g. zinc sulfide or cadomium sulfide; and photo-soluble inorganic fine particles of e.g. zinc oxide.

Further, in the method of forming a shell by irradiation with microwaves as described hereinafter, the core fine particles are preferably particles made of a material having a dielectric constant of at least 10 (preferably from 10 to 200). When the dielectric constant of the material of the core fine particles is at least 10, microwaves can easily be absorbed, and accordingly, the core particles can be heated selectively to a high temperature (at least 100° C.) by microwaves. The dielectric constant can be calculated from the values of the reflection coefficient and the phase measured by applying an electric field to a sample by a bridge circuit by means of a network analyzer.

The material having a dielectric constant of at least 10 may, for example, be zinc oxide, titanium oxide, ITO (indium tin oxide), aluminum oxide, zirconium oxide, zinc sulfide, gallium arsenide, iron oxide, cadmium oxide, copper oxide, bismuth oxide, tungsten oxide, cerium oxide, tin oxide, gold, silver, copper, platinum, palladium, ruthenium, iron platinum or carbon. Among them, as core particles, it is preferred to use zinc oxide, titanium oxide, ITO, aluminum oxide, zirconium oxide, zinc sulfide, cerium oxide or tin oxide, since it is thereby possible to obtain a film having high transparency.

The average primary particle size of the core fine particles is preferably from 5 to 75 nm, particularly preferably from 5 to 70 nm. When the average primary particle size of the core fine particles is at least 5 nm, a substrate provided with an undercoat layer employing the obtained aggregates of core-shell type fine particles will have a large film surface area due to the concave-convex derived from particles as compared with a flat substrate, whereby the water repellency will be improved. When the average primary particle size of the core fine particles is at most 75 nm, the surface area of the undercoat layer employing the obtainable aggregates of core-shell type fine particles will be sufficiently large, whereby ultra-water-repellency can easily be obtainable. Further, the average aggregate particle size of the aggregates of core particles is preferably from 100 to 1,200 nm, particularly preferably from 150 to 500 nm. When the average aggregate particle size is at least 100 nm, voids will be formed among aggregate particles when applied on the substrate, whereby when water drops are dropped thereon, ultra-water-repellency becomes easily obtainable including air. When the average aggregate particle size is at most 1,200 nm, the concave-convex structure can be maintained even after abrasion.

Various methods may be employed to disperse the core fine particles in a dispersing medium. For example, a method of preparing core fine particles in a medium, or a method of adding the after-mentioned dispersing medium and dispersant to a core fine particle powder, followed by deflocculation by means of a dispersing machine such as a ball mill, a beads mill, a sand mill, a homomixer or a paint shaker, may be mentioned. The solid content concentration in the dispersion liquid of core fine particles thus obtained is preferably at most 50 mass %. If the solid content concentration exceeds 50 mass %, the stability of the dispersion liquid is likely to deteriorate.

Then, circumference of clusters of core fine particles is covered with a metal oxide such as SiO₂ to obtain aggregates of core-shell type fine particles. Specifically, they are obtained by reacting a precursor for a metal oxide (such as SiO₂) in the presence of clusters of core fine particles to precipitate a metal oxide (SiO₂) on the surface of the clusters of core fine particles to form a shell.

The method for producing core-shell type fine particles may be a gas phase method or a liquid phase method. In a method by a gas phase method, core-shell type fine particles can be produced by applying plasma to the material for core fine particles and the SiO₂ material such as metal Si.

On the other hand, in a method by a liquid phase method, firstly, a precursor for a metal oxide such as SiO₂ and, as the case requires, water, an organic solvent, an acid, an alkali, a curing catalyst, etc. are added to a dispersion liquid having clusters of core fine particles dispersed in a dispersing medium, to prepare a raw material liquid. Then, at the same time as the low material liquid is heated, the precursor for a metal oxide such as SiO₂ is hydrolyzed to precipitate a metal oxide such as SiO₂ on the surface of the clusters of core fine particles to form a shell thereby to obtain aggregates of core-shell type fine particles.

The concentration of core fine particles in the dispersion liquid having the above clusters of core fine particles dispersed in a dispersing medium, is preferably from 0.1 to 40 mass %, more preferably from 0.5 to 20 mass %, based on the dispersion liquid. When the concentration of core fine particles is within the above range, the stability of the dispersion liquid is good, and the production efficiency for core shell particles will be good.

The amount of the precursor for a metal oxide is preferably an amount whereby the shell thickness will be from 1 to 10 nm, more preferably an amount whereby the shell thickness will be from 2 to 5 nm. The amount of the precursor for a metal oxide (calculated as a metal oxide) is specifically preferably from 3 to 1,000 parts by mass per 100 parts by mass of the core fine particles.

The alkali may, for example, be potassium hydroxide, sodium hydroxide, ammonia, ammonium carbonate, ammonium hydrogencarbonate, dimethylamine, triethylamine or aniline, and ammonia is preferred, since it is removable by heating. The amount of the alkali is preferably an amount whereby the pH of the raw material liquid will be from 8.5 to 10.5, more preferably an amount whereby the pH will be from 9.0 to 10.0, since the precursor for a metal oxide will thereby be three dimensionally polymerized to readily form a dense shell.

The acid may, for example, be hydrochloric acid or nitric acid. Here, zinc oxide particles are soluble in an acid, and when zinc oxide particles are used as core particles, the hydrolysis of the precursor for a metal oxide is preferably carried out by an alkali. The amount of the acid is preferably an amount whereby the pH of the raw material liquid will be from 3.5 to 5.5.

The curing catalyst may, for example, be a metal chelate compound, an organic tin compound, a metal alcoholate or a metal fatty acid salt, and from the viewpoint of the strength of the shell, a metal chelate compound or an organic tin compound is preferred, and a metal chelate compound is particularly preferred. When a metal chelate compound is added, chain solid fine particles are likely to be formed as a by-product, whereby a structure wherein hollow fine particles are linked to one another by the chain solid fine particles, is likely to be formed.

The metal chelate may, for example, be an aluminum chelate compound (such as aluminum acetyl acetonate, aluminum bisethylacetoacetate monoacetyl acetonate, aluminum-di-n-butoxide-monoethylacetoacetate, aluminum-di-isopropoxide-monomethylacetoacetate or diisopropoxy aluminum ethyl acetate), a titanium chelate compound (such as titanium acetylacetonate or titanium tetraacetylacetonate), a copper chelate compound (such as copper acetylacetonate), a cerium chelate compound (such as cerium acetylacetonate), a chromium chelate compound (such as chromium acetylacetonate), a cobalt chelate compound (such as cobalt acetylacetonate), a tin chelate compound (such as tin acetylacetonate), an iron chelate compound (such as iron(III) acetylacetonate), a manganese chelate compound (such as manganese acetylacetonate), a nickel chelate compound (such as nickel acetylacetonate), a zinc chelate compound (such as zinc acetylacetonate) or a zirconium chelate compound (such as zirconium acetylacetonate). From the viewpoint of the strength of hollow fine particles, a metal acetylacetonate is preferred.

The amount of the curing catalyst (calculated as a metal oxide) is preferably from 0.1 to 20.0 parts by mass, more preferably from 0.2 to 8.0 parts by mass, per 100 parts by mass of the amount of the precursor for a metal oxide (calculated as a metal oxide).

In a case where the metal oxide is SiO₂, the precursor for SiO₂ may be at least one compound selected from silicic acid, a silicate and a silicic acid alkoxide. Such a compound is a compound having at least one hydroxyl group or hydrolyzable group (such as a halogen atom or an alkoxy group) bonded to a silicon atom. For such a precursor, different types of compounds may be used in combination. Further, such a precursor may be a partially hydrolyzed condensate.

The silicic acid may be silicic acid obtainable by a method of decomposing an alkali metal silicate with an acid, followed by dialysis; a method of deflocculating an alkali metal silicate; or a method of contacting an alkali metal silicate with an acid-form cation exchange resin.

The silicate may, for example, be an alkali metal silicate such as sodium silicate or potassium silicate; an ammonium silicate such as tetraethylammonium silicate; or a salt of silicic acid with an amine (such as ethanolamine).

The silicic acid alkoxide may be a compound having four alkoxy groups bonded to a silicon atom, such as ethyl silicate. Otherwise, it may be a silicic acid alkoxide having from 1 to 3 organic groups bonded to a silicon atom. As such an organic group, a monovalent organic group containing a functional group such as a vinyl group, an epoxy group or an amino group; or a fluorinated monovalent organic group such as a perfluoroalkyl group or a perfluoroalkyl group containing an etheric oxygen atom, may, for example, be mentioned.

The silicic acid alkoxide having a silicon atom having such organic groups bonded thereto may, for example, be vinyl trimethoxysilane, vinyl triethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane or perfluoroethyltriethoxysilane.

As a dispersing medium in which aggregates of core fine particles are dispersed and the hydrolytic reaction of a precursor for a metal oxide such as SiO₂ is carried out at the time of producing the dispersion liquid of core-shell type fine particles, the following media may, for example, be mentioned.

Water, an alcohol (such as methanol, ethanol or isopropanol), a ketone (such as acetone or methyl ethyl ketone), an ether (such as tetrahydrofuran or 1,4-dioxane), an ester (such as ethyl acetate or methyl acetate), a glycol ether (such as ethylene glycol monoalkyl ether), a nitrogen-containing compound (such as N,N-dimethylacetamide or N,N-dimethylformamide), a sulfur-containing compound (such as dimethylsulfoxide), etc.

The dispersing medium for core fine particles is not necessarily required to contain water, but when it is used as it is in the subsequent step for hydrolytic condensation of the precursor for a metal oxide, the dispersing medium is preferably water alone or a mixed medium of water and the above organic solvent. Such an organic solvent is an organic solvent which is at least partially soluble in water or preferably capable of partially dissolving water, and it is most preferably an organic solvent miscible with water.

In a case where the dispersing medium is a mixed medium of water with the above organic solvent, such a mixed medium preferably contains at least 5 mass % of water, based on the entire medium. If the content of water is less than 5 mass %, the reaction may not sufficiently proceed. Further, it is necessary to let water be present in the system in an amount of at least the stoichiometrical amount to the hydroxyl groups or hydrolyzable groups bonded to silicon atoms in the precursor for SiO₂ in the dispersing medium.

Further, at the time of producing the dispersion liquid of core-shell type fine particles, the solid content concentration (the total of core particles and shell precursor (calculated as a metal oxide)) in the reaction solution is preferably within a range of at least 0.1 mass % and at most 30 mass %, particularly preferably within a range of at least 1 mass % and at most 20 mass %. If the solid content concentration exceeds 30 mass %, the stability of the dispersion liquid of fine particles tends to deteriorate, such being undesirable, and if it is less than 0.1 mass %, the productivity of the obtainable aggregates of hollow SiO₂ particles tends to be very low, such being undesirable.

Further, at the time of producing the dispersion liquid of core-shell type fine particles, in order to increase the ionic strength of the reaction solution to facilitate formation of a shell from the precursor for e.g. SiO₂, an electrolyte such as sodium chloride, potassium chloride, magnesium chloride, sodium nitrate, potassium nitrate, sodium sulfate, potassium sulfate, ammonia or sodium hydroxide may be added. Further, by using such an electrolyte, the pH of the reaction solution may be adjusted.

Heating of the raw material liquid may be carried out not only by usual heating but also by irradiation with microwaves. The microwaves mean electromagnetic waves having a frequency of from 300 MHz to 300 GHz. Usually, microwaves having a frequency of 2.45 GHz are used, but the microwaves are not limited thereto, and a frequency may be selected so that the object to be heated can effectively be thereby heated. By the radio law, frequency bands so-called ISM bands are prescribed for applications to use radio waves for the purpose of other than communication, and it is possible to use microwaves of e.g. 433.92 (±0.87) MHz, 896 (±10) MHz, 915 (±13) MHz, 2375 (±50) MHz, 2450 (±50) MHz, 5800 (±75) MHz, 24125 (±125) MHz, etc.

The output power of microwaves is preferably an output power whereby the raw material liquid is heated to from 30 to 500° C., more preferably an output power whereby the raw material liquid is heated to from 50 to 300° C. When the temperature of the raw material liquid is at least 30° C., a dense shell can be formed in a short time. When the temperature of the raw material liquid is at most 500° C., the amount of a metal oxide precipitating on other than the surface of core fine particles can be suppressed.

The time for irradiation with microwaves may suitably be adjusted to a time wherein a shell having a desired thickness can be formed depending upon the output power of microwaves (the temperature of the raw material liquid), and it is, for example, from 10 seconds to 60 minutes.

As mentioned above, it is possible to heat the core fine particles selectively and to a high temperature (e.g. at least 100° C.) by a method of applying microwaves to a raw material liquid containing core fine particles made of a material having a dielectric constant of at least 10, and a precursor for a metal oxide. Therefore, even if the entire raw material liquid becomes a high temperature (e.g. at least 100° C.), core fine particles are heated to a higher temperature, whereby hydrolysis of the precursor for a metal oxide preferentially proceeds on the surface of core particles, whereby a metal oxide is selectively precipitated on the surface of core fine particles. Accordingly, the amount of particles made of a shell-forming material (a metal oxide) precipitated alone on other than the surface of core fine particles, can be suppressed. Further, the shell can be formed under a high temperature condition, whereby the shell can be formed in a short time. Further, the shell becomes denser, whereby the abrasion resistance of the obtained water-repellent substrate will be improved, such being desirable.

Then, the obtained aggregates of core-shell type fine particles are disintegrated to obtain aggregates (A) having a desired aggregate particle size. As the disintegrating method, the same one as in the above-described method (2) may be used.

In a case where the aggregates (A) are aggregates of hollow fine particles, a step of dissolving the core particles is further carried out. The step of dissolving the core particles may be carried out either before or after the disintegration step.

The removal of core particles can be carried out by dissolving or decomposing the core fine particles in the core-shell type fine particles. As a method for dissolving or decomposing the core fine particles in the core-shell type fine particles, one or more methods selected from decomposition by heat, decomposition by an acid and decomposition by light, may be mentioned.

In a case where the core fine particles are made of a heat decomposable organic resin, such core fine particles may be removed by heating in a gas phase or a liquid phase. The heating temperature is preferably within a range of from 200 to 1,000° C. If it is lower than 200° C., the core fine particles are likely to remain, and if it exceeds 1,000° C., SiO₂ is likely to melt, such being undesirable.

In a case where the core fine particles are made of an acid-soluble inorganic compound, such core fine particles can be removed by adding an acid or an acidic cation exchange resin in a gas phase or a liquid phase.

In a case where the core particles are to be removed by dissolving them by an acid, such an acid may be an inorganic acid or an organic acid. The inorganic acid may, for example, be hydrochloric acid, sulfuric acid or nitric acid. The organic acid may, for example, be formic acid, acetic acid, propionic acid or oxalic acid. In such a case, ions formed by dissolution of the core particles may be removed by ultrafiltration.

Further, it is also preferred to employ an acidic cation exchange resin instead of a liquid acid or acid solution. The acidic cation exchange resin is preferably a polyacrylic resin type or polymethacrylic resin type, particularly preferably a polystyrene type having a sulfonic acid group which is more strongly acidic. In such a case, after dissolving the core particles, the cation exchange resin is separated by solid-liquid separation such as filtration to obtain a dispersion liquid of hollow SiO₂ fine particles. By the method of dissolving the core fine particles by adding an acid, it takes long time for removal by ultrafiltration of ions formed by dissolution of the core particles, and therefore, it is preferred to dissolve the core fine particles by means of the acidic cation exchange resin.

Further, in a case where the core fine particles are made of an inorganic compound soluble under irradiation with light, such core fine particles may be removed also by irradiation with light in a gas phase or in a liquid phase. The light is preferably an ultraviolet ray having a wavelength of at most 380 nm.

The aggregates (A) are preferably aggregates (A) having hollow fine particles aggregated, which are obtainable by the above-mentioned method (2-2). Further, such aggregates (A) are particularly preferably aggregates (A) obtainable under irradiation with microwaves at the time of preparing aggregates of core-shell type fine particles. Further, it is preferred to use zinc oxide as the core particles. In a case where zinc oxide is used as the core particles and heating is carried out by microwaves, the core particles are selectively heated, whereby a dense shall can be formed, and the strength of the obtained undercoat layer will be increased, such being desirable.

In order to obtain ultra-water-repellency, relatively large concave-convex is required, and accordingly, it is preferred to use aggregate particles. However, the scattering intensity of light becomes high as the particle size increases, whereby the transparency is likely to be lost. On the other hand, the scattering intensity of light depends also on the refractive index of particles, and becomes low as the difference in the refractive index from air (refractive index: 1) is small. Accordingly, the refractive index of the aggregates (A) is preferably at most 1.4, particularly preferably from 1.05 to 1.35. When the refractive index of the aggregates is at least 1.05, the strength of the undercoat layer can sufficiently be secured. When the refractive index of the aggregates is at most 1.35, it is possible to obtain an undercoat layer having high transparency. Thus, by adjusting the refractive index of the aggregates (A), it is possible to obtain a water-repellent substrate excellent in both water-repellency and transparency.

In the present invention, the aggregates (A) having hollow fine particles aggregated has a refractive index of from about 1.1 to 1.3. Accordingly, a water repellent substrate obtainable by using such aggregates (A) exhibits good transparency, can secure a sufficient visual field and further exhibits an excellent antireflection performance. Accordingly, it is particularly useful for a vehicle window of e.g. an automobile or for a cover for a solar cell.

In the present invention, the refractive index of the aggregates (A) is not meant for refractive indices of individual materials constituting the aggregates, and is meant for the refractive index as the entire aggregates. The refractive index as the entire aggregates is calculated from the minimum reflectance measured by a spectrophotometer. In a case where the undercoat layer contains a binder, the refractive index of a film is calculated by the minimum reflectance measured by a spectrophotometer in a state as the film including the binder, and the refractive index as the entire aggregates is calculated from the weight ratio of the aggregates and the binder.

The underlayer contains a metal oxide type binder in addition to the aggregates (A). The metal oxide type binder is a component formed from a binder material containing a metal compound (B) which is converted to a metal oxide by hydrolytic condensation or pyrolysis (hereinafter sometimes referred to simply as “metal compound (B)”). The metal compound (B) is preferably a hydrolyzable metal compound having a hydrolyzable group bonded thereto, a partially hydrolyzed condensate of such a hydrolyzable metal compound or a metal-coordinated compound having a ligand coordinated. The hydrolyzable metal compound becomes a metal oxide by a hydrolytic condensation reaction, and the metal-coordinated compound becomes a metal oxide by pyrolysis. The metal atom is preferably at least one metal atom selected from the group consisting of a silicon atom, an aluminum atom, a titanium atom, a tin atom and a cerium atom, particularly preferably a silicon atom.

The hydrolyzable group may, for example, be an alkoxy group, an isocyanate group or a halogen atom, and it is preferably an alkoxy group. With the alkoxy group, the hydrolytic reaction and the condensation reaction proceed mildly. Further, a hydrolytically condensable metal compound (B) having an alkoxy group as a hydrolyzable group has a merit in that it is dispersed without agglomeration and will function sufficiently as a binder for the aggregates (A). The alkoxy group may be a methoxy group, an ethoxy group or an isopropoxy group. The ligand may, for example, be acetylacetate, acetylacetonate, ethylacetoacetate, lactate, or octylene glycolate.

In the metal compound (B), it is preferred that at least two hydrolyzable groups are bonded to a metal atom, or at least two ligands coordinated to a metal atom. When at least two hydrolyzable groups are bonded (or coordinated), such a metal compound (B) becomes a strong binder when it is converted to a metal oxide type binder.

To the metal atom in the hydrolytically condensable metal compound (B), a group other than a hydrolyzable group may be bonded. As the group other than a hydrolyzable group, a monovalent organic group may be mentioned. The monovalent organic group may, for example, be an alkyl group; an alkyl group having a functional group such as a chlorine atom, an epoxy group, an amino group, an acyloxy group or a mercapto group; or an alkenyl group, and specifically, it is preferably the same group as the after-mentioned R^{f}, R^{a}, R^{b} or R.

As the hydrolytically condensable metal compound (B), a hydrolyzable silicon compound having a silicon atom to which hydrolyzable groups are bonded, or a partially hydrolyzed condensate of such a silicon compound is preferred. Specifically, at least one hydrolyzable silicon compound selected from the group consisting of the following compound (B-1), the following compound (B-2), the following compound (B-3) and the following compound (B-4), or a partially hydrolyzed condensate of such a hydrolyzable silicon compound, is preferred.

R^{a}—Si(R)ₘ(X²)₍₃₋ₘ₎ (B-1)

R^{f}—Si(R)ₖ(X¹)₍₃₋ₖ₎ (B-2)

R^{b}—Si(R)ₙ(X³)₍₃₋ₙ₎ (B-3)

Si(X⁴)₄ (B-4)

In the above formulae, the symbols have the following meanings.

R^{a}: a C₁₋₂₀ alkyl group or a C₂₋₆ alkenyl group.

R^{f}: a C₁₋₂₀ polyfluoroalkyl group.

R^{b}: an organic group having at most 10 carbon atoms and having a functional group selected from the group consisting of an epoxy group, an amino group, an acyloxy group, a mercapto group and a chlorine atom.

R: an alkyl group having at most 6 carbon atoms, or a C₂₋₆ alkenyl group.

X¹, X², X³ and X⁴: each independently is a halogen atom, a C₁₋₆ alkoxy group, a C₁₋₆ acyloxy group or an isocyanate group.

k, m and n: each independently is 0 or 1.

When R^{a} is a C₁₋₂₀ alkyl group, it may, for example, be a methyl group, an ethyl group, an isopropyl group, a t-butyl group, a n-hexyl group, a n-heptyl group, a n-octyl group, a n-nonyl group or a n-decyl group, preferably a methyl group, an ethyl group or an isopropyl group. When R^{a} is a C₂₋₆ alkenyl group, it is preferably a linear alkenyl group and preferably has from 2 to 4 carbon atoms. Specifically, a vinyl group, an allyl group or a butenyl group may, for example, be mentioned, and a vinyl group or an allyl group is preferred.

R^{f} is a group corresponding to a C₁₋₂₀ alkyl group wherein at least two hydrogen atoms bonded to carbon atoms are substituted by fluorine atoms, particularly preferably a perfluoroalkyl group, wherein all hydrogen atoms are substituted by fluorine atoms. As R^{f}, a group represented by the following formula (3) is also preferred. Here, such a group preferably has from 1 to 10 carbon atoms.

F(CF₂)ₚ(CH₂)_{q}— (3)

In the above formula, p is an integer of from 1 to 8, q is an integer of from 2 to 4, and p+q is from 2 to 12, preferably from 6 to 11. As p, an integer of from 4 to 8 is preferred. As q, 2 or 3 is preferred.

The perfluoroalkyl group is preferably CF₃—, F(CF₂)₂—, F(CF₂)₃— or F(CF₂)₄—. The group represented by the formula (3) is preferably F(CF₂)₈(CH₂)₂—, F(CF₂)₈(CH₂)₃—, F(CF₂)₆(CH₂)₂—, F(CF₂)₆(CH₂)₃—, F(CF₂)₄(CH₂)₂— or F(CF₂)₄(CH₂)₃—.

When the hydrolyzable group X¹, X², X³ or X⁴ is a halogen atom, it is preferably a chlorine atom. Further, the C₁₋₆ alkoxy group is preferably a methoxy group, an ethoxy group or an isopropoxy group, and the C₁₋₆ acyloxy group is preferably an acetyloxy group or a propionyloxy group. Each of X¹ and X² which are independent of each other, is preferably a chlorine atom, the above alkoxy group or an isocyanate group.

R^{b} is an organic group having at most 10 carbon atoms and having a functional group selected from the group consisting of an epoxy group, an amino group, an acyloxy group, a mercapto group and a chlorine atom. The functional group is preferably an epoxy group, an amino group or an acyloxy group. Further, when the functional group is an acyloxy group, it is preferably an acetoxy group, a propionyloxy group or a butyryloxy group. Here, “at most 10 carbon atoms” does not include the number of carbon atoms contained in the above functional group.

Each of k, m and n which are independent of one another, is 0 or 1. Each of k, m and n is preferably 0. When each of k, m and n is 0, the hydrolyzable metal compounds (B-1) to (B-4) will have three hydrolyzable groups, whereby it is possible to firmly bond the metal compounds to one another or the metal compounds to the inner layer surface, such being desirable.

Compound (B-1) may, for example, be methyltriethoxysilane, methyltrimethoxysilane, ethyltriethoxysilane, dimethyldiethoxysilane, dimethyldimethoxysilane, ethenyldimethoxysilane, propenyldimethoxysilane, n-heptyltrimethoxysilane, n-heptyltriethoxysilane, n-octyltrimethoxysilane or n-octyltriethoxysilane.

Compound (B-2) may, for example, be (3,3,3-trifluoropropyl)trimethoxysilane, (3,3,3-trifluoropropyl)methyldimethoxysilane, (3,3,3-trifluoromethyl)trimethoxysilane, (3,3,3-trifluoromethyl)methyldimethoxysilane, 3-(heptafluoroethyl)propyltrimethoxysilane, 3-(nonafluorohexyl)propyltrimethoxysilane, 3-(nonafluorohexyl)propyltriethoxysilane, 3-(tridecafluorooctyl)propyltrimethoxysilane, 3-(tridecafluorooctyl)propyltriethoxysilane or 3-(heptadecafluorodecyl)propyltrimethoxysilane.

Compound (B-3) may, for example, be 3-glycidoxypropyltrimethoxysilane, 3-glycidoxypropylmethyldimethoxysilane, 3-aminopropyltrimethoxysilane, N-(2-aminoethyl)-3-aminopropyltrimethoxysilane or acetoxymethyltrimethoxysilane.

Compound (B-4) may, for example, be tetraethoxysilane, tetramethoxysilane, tetraisopropoxysilane, tetraisocyanatesilane or tetrachlorosilane.

Among the compounds (B-1) to (B-4), compound (B-4) or a partially hydrolyzed condensate of such compound (B-4) is preferred, and more specifically, tetraethoxysilane, partially hydrolyzed condensate of tetraethoxysilane, tetramethoxysilane or a partially hydrolyzed condensate of tetramethoxysilane is preferred.

Further, as a metal compound (B) having hydrolyzable groups, tetraisopropoxytitanium, tetrabutoxytitanium, triisopropoxyaluminum, tetrabutoxyzirconium or tetrapropoxyzirconium may also be suitably used.

In a case where the metal compound (B) is a metal coordination compound, it may, for example, be aluminum tris(acetyl acetate), aluminum (ethylacetoacetate)diisopropoxide, aluminum tris(ethylacetoacetate), titanium bis(acetyl acetate)diisopropoxide, titanium tetra(acetyl acetate), titanium bis(octylene glycolate)dibutoxide, titanium bis(lactate)dihydroxide, titanium bis(triethanolaminolate), titanium bis(ethylacetoacetate)diisopropoxide, polyhydroxytitanium stearate, zirconium (tetraacetyl acetate), zirconium (acetyl acetate)tributoxide, zirconium bis(acetyl acetate)dibutoxide or zirconium (acetyl acetate)(ethylacetoacetate)dibutoxide, preferably aluminum tris(acetyl acetate).

Further, when the metal compound (B) is a compound having fluorine atoms, there is a merit such that the chemical resistance or durability such as abrasion resistance is high.

The undercoat layer is preferably formed by applying a dispersion liquid comprising the aggregates (A) of metal oxide fine particles, the binder material and a dispersing medium (hereinafter sometimes referred to as the dispersion liquid (1)) on at least one side of a substrate, followed by drying.

As the dispersing medium in the dispersion liquid (1), it is preferred to use the medium used in the production of the aggregates (A) as it is. For example, in the method (2-2), it is preferred to use the solvent used in the step for hydrolytic condensation of the metal oxide precursor, etc. as it is. That is, other than water, an organic solvent such as an alcohol, a ketone, an ester, an ether, a glycol ether, a nitrogen-containing compound or a sulfur-containing compound may also be used. However, if desired, from such a solvent, e.g. water may be removed by such a means as azeotropic distillation to bring the solvent composed substantially solely of an organic solvent, or inversely, an organic solvent may be removed to bring the solvent composed of water or an aqueous solvent.

The concentration of the aggregates (A) contained in the dispersion liquid (1) is preferably from 0.1 to 5 mass %, particularly preferably from 0.5 to 3 mass %, based on the dispersion liquid. The reason is such that an undercoat layer thereby obtainable will have a proper concave-convex structure, whereby ultra-water-repellency is readily obtainable.

The total amount of the aggregates (A) and the metal compound (B) contained in the dispersion liquid is preferably from 0.1 to 10 mass %, more preferably from 0.5 to 10 mass %, particularly preferably from 1 to 5 mass %, based on the dispersion liquid (1). When the solid content concentration is at least 0.5 mass %, it is possible to form an undercoat layer having a sufficient thickness to obtain ultra-water-repellency. When the solid content concentration is at most 10 mass %, it is possible to secure transparency as the thickness of the undercoat layer will not be too thick.

Further, the ratio of the aggregates (A) to the metal compound (B) contained in the dispersion liquid (1) is preferably aggregates (A)/metal compound (B)=4/6 to 9/1 by weight ratio calculated as oxides. When aggregates (A)/metal compound (B) is at least 4/6, concave-convex of the film will be sufficient, and ultra-water-repellency can be obtained. When aggregates (A)/metal compound (B) is at most 9/1, the strength of the film can sufficiently be secured.

The dispersion liquid (1) may contain additives such as a dispersing agent, a leveling agent, an ultraviolet absorber, a viscosity-controlling agent, an antioxidant, a surfactant, etc. The dispersing agent may, for example, be acetylacetone or polyvinyl alcohol, preferably acetylacetone. Further, various pigments such as titania, zirconia, white lead and red iron oxide may be incorporated. The amount of such additives is preferably at most 10 mass % based on the total amount of the solid content contained in the dispersion liquid (1).

As the method for applying the dispersion liquid (1) to the substrate surface, a known method such as roller coating, flexo coating, bar coating, die coating, gravure coating, roll coating, flow coating, spray coating, online spray coating, ultrasonic spray coating, inkjet coating or dip coating may be mentioned. The online spray coating is a method of carrying out spray coating on the line for forming the substrate, whereby a step of re-heating the substrate can be omitted, and the article can be produced at a low cost, such being useful. The dispersion liquid (1) is preferably applied in a thickness of from 500 to 20,000 nm (preferably in a thickness of from 1,000 to 10,000 nm) in a state containing a dispersing medium (in a wet state), although it may depends also on the solid content concentration.

Removal of the dispersing medium is preferably carried out by drying at a temperature of from room temperature (about 20° C.) to 700° C. after applying the dispersion liquid (1) on the substrate. By the removal of the dispersing medium, a layer containing the aggregates (A) of metal oxide fine particles and the metal compound (B) is formed on the substrate surface. And, in the process of drying the dispersing medium, the metal compound (B) is converted to a metal type binder, and an undercoat layer is formed. For the formation of the undercoat layer, drying at a temperature of from room temperature to 700° C. is sufficient, but for the purpose of e.g. increasing the mechanical strength of the coating film, further heating may be carried out as the case requires.

The thickness (the thickness after drying) of the undercoat layer thus formed is usually from 100 to 1,500 nm, preferably from 120 to 1,000 nm, particularly preferably from 150 to 800 nm. When the thickness is at least 100 nm, if a water droplet is dropped on the film, a layer of air is partially formed between the water droplet and the underlayer surface, whereby ultra-water-repellency will be obtained. When the thickness is at most 1,500 nm, sufficient transparency can be secured. Here, the thickness of the undercoat layer is defined to be an average value in distance between the substrate surface and the convex peak most remote from the substrate when the cross-section of the substrate provided with the undercoat layer is observed by a scanning electron microscope. The surface of the undercoat layer has a concave-convex structure. Such a structure has an average surface roughness (Ra) of from about 60 to 300 nm.

Then, a water-repellent layer is formed on the undercoat layer of the substrate provided with the undercoat layer. Reflecting the concave-convex structure of the surface of the undercoat layer, the surface of the water-repellent layer also has a concave-convex structure.

The water-repellent agent to form the water-repellent layer is not particularly limited, and various water-repellent agents may be used. A silicone type water-repellent agent or a water-repellent agent made of a hydrophobic organic silicon compound may preferably be used.

As the silicone type water-repellent agent, a linear silicone resin is preferred. Specifically, a linear dialkylpolysiloxane or alkylpolysiloxane may be used. Such a silicone resin may have hydroxyl groups at its terminals, or the terminals may be sealed with alkyl groups or alkenyl groups. Specifically, dimethylpolysiloxane having hydroxyl groups at both terminals, dimethylpolysiloxane having both terminals sealed with e.g. vinyl groups, methylhydrogen polysiloxane, alkoxy-modified dimethylpolysiloxane or fluoroalkyl-modified dimethyl silicone may, for example, be mentioned, and alkoxy-modified dimethylpolysiloxane is preferred.

By using such a silicone type water-repellent agent, the friction of the surface of the water-repellent article will be small, and such being effective for maintaining the concave-convex structure.

The hydrophobic organic silicon compound is preferably a compound having a silicon atom to which a hydrophobic organic group (bonded to the silicon atom by carbon-silicon bond) and a hydrolyzable group are bonded.

The hydrophobic organic group is preferably a monovalent hydrophobic organic group. Specifically, a monovalent hydrocarbon group or a monovalent fluorinated hydrocarbon group is preferred. The monovalent hydrocarbon group is preferably a C₁₋₂₀ alkyl group, particularly preferably a C₄₋₁₀ linear alkyl group. Specifically, a n-butyl group, a n-pentyl group, a n-hexyl group, a n-heptyl group or a n-octyl group may be mentioned, and a n-heptyl group or a n-octyl group is preferred. In addition, a C₃₋₁₀ cycloalkyl group is also preferred, and specifically, a cyclohexyl group is preferred.

The monovalent fluorinated hydrocarbon group is a group having at least one hydrogen atom contained in the above monovalent hydrocarbon group substituted by a fluorine atom, and a polyfluoroalkyl group is preferred.

The hydrolyzable group may, for example, be an alkoxy group, an isocyanate group, an acyloxy group or a halogen atom. The alkoxy group is preferably a methoxy group, an ethoxy group or an isopropoxy group. The acyloxy group is preferably an acetyloxy group or a propionyloxy group. The halogen atom is preferably a chlorine atom.

The hydrophobic organic silicon compound is preferably a compound represented by the following formula (1) or a compound represented by the following formula (2), particularly preferably a compound represented by the following formula (1).

R^{f}—Si(R)ₖ(X¹)₍₃₋ₖ₎ (1)

R^{a}—Si(R)ₘ(X²)₍₃₋ₘ₎ (2)

In the above formulae, the symbols have the following meanings.

R^{f}: a C₁₋₁₂ polyfluoroalkyl group.

R^{a}: a C₁₋₂₀ alkyl group or a C₃₋₁₀ cycloalkyl group.

R: an alkyl group having at most 6 carbon atoms, or an alkenyl group having at most 6 carbon atoms.

X¹ and X²: each independently is a halogen atom, a C₁₋₆ alkoxy group, a C₁₋₆ acyloxy group or an isocyanate group.

k and m: each independently is 0 or 1.

R^{f} is a C₁₋₁₂ polyfluoroalkyl group. Such a polyfluoroalkyl group is preferably a group corresponding to an alkyl group wherein at least two hydrogen atoms bonded to carbon atoms are substituted by fluorine atoms, particularly preferably a perfluoroalkyl group having all hydrogen atoms substituted by fluorine atoms, or a group represented by the following formula (3).

F(CF₂)ₚ(CH₂)_{q}— (3)

In the formula, p is an integer of from 1 to 8, preferably from 4 to 10. q is an integer of from 2 to 4, preferably 2 or 3. p+q is from 2 to 12, preferably from 6 to 11.

The perfluoroalkyl group is preferably CF₃—, F(CF₂)₂—, F(CF₂)₃— or F(CF₂)₄—. The group represented by the formula (3) is preferably F(CF₂)₈(CH₂)₂—, F(CF₂)₈(CH₂)₃—, F(CF₂)₆(CH₂)₂—, F(CF₂)₆(CH₂)₃—, F(CF₂)₄(CH₂)₂— or F(CF₂)₄(CH₂)₃—.

R^{a} is a C₁₋₂₀ alkyl group or a C₃₋₁₀ cycloalkyl group. In a case where R^{a} is a C₁₋₂₀ alkyl group, such a group preferably has a linear structure. Further, it preferably has from 4 to 10 carbon atoms. Specifically, a n-butyl group, a n-pentyl group, a n-hexyl group, a n-heptyl group or a n-octyl group may, for example, be mentioned, and a n-heptyl group or a n-octyl group is preferred. In a case where R^{a} is a C₃₋₁₀ cycloalkyl group, it is preferably a cyclohexyl group.

R is an alkyl group having at most 6 carbon atoms, or an alkenyl group having at most 6 carbon atoms. Such a group preferably has a linear structure. The alkyl group having at most 6 carbon atoms may, for example, be a methyl group, an ethyl group, a n-propyl group, a n-butyl group, a n-pentyl group or a n-hexyl group. The alkenyl group having at most 6 carbon atoms may, for example, be a propenyl group or a butenyl group.

Each of X¹ and X² which are independent of each other, is a halogen atom, a C₁₋₆ alkoxy group, a C₁₋₆ acyloxy group or an isocyanate group. The halogen atom is preferably a chlorine atom. The C₁₋₆ alkoxy group preferably has a linear structure and preferably has from 1 to 3 carbon atoms. In a case where X¹ or X² is a C₁₋₆ acyloxy group, it may, for example, be an acetyloxy group or a propionyloxy group, preferably an acetyloxy group.

Each of k and m which are independent of each other, is 0 or 1.

The following compounds may be mentioned as the compound (1).

F(CF₂)ₑSi(NCO)₃, F(CF₂)_{f}Si(Cl)₃, F(CF₂)_{g}Si(OCH₃)_{g} (wherein each of e, f and g which are independent of one another, is an integer of from 1 to 4.)

More specifically, the following compounds may be mentioned.

(CF₂)₈(CH₂)₂Si(NCO)₃, F(CF₂)₈(CH₂)₂Si(Cl)₃, F(CF₂)₈(CH₂)₂Si(OCH₃)₃, F(CF₂)₆(CH₂)₂Si(NCO)₃, F(CF₂)₆(CH₂)₂Si(Cl)₃, F(CF₂)₆(CH₂)₂Si(OCH₃)₃, F(CF₂)₄(CH₂)₂Si(NCO)₃, F(CF₂)₄(CH₂)₂Si(Cl)₃, F(CF₂)₄(CH₂)₂Si(OCH₃)₃.

Among them, F(CF₂)₈(CH₂)₂Si(NCO)₃, F(CF₂)₈(CH₂)₂Si(Cl)₃ or F(CF₂)₈(CH₂)₂Si(OCH₃)₃ is preferred.

The compound (2) may, for example, be methyltrimethoxysilane, methyltriethoxysilane, ethyltriethoxysilane, dimethyldiethoxysilane, dimethyldimethoxysilane, trimethylmethoxysilane, trimethylethoxysilane, triethylmethoxysilane, triethylethoxysilane, n-decyltrimethoxysilane, n-decyltriethoxysilane, cyclohexyltrimethoxysilane or cyclohexyltriethoxysilane. Among them, dimethyldimethoxysilane, n-decyltrimethoxysilane or cyclohexyltrimethoxysilane is preferred.

The above compound (1) or (2) may be used alone or may be a partially hydrolyzed condensate of at least one compound selected from the above-mentioned group of compounds.

Further, the water-repellent layer may be formed from a water-repellent agent containing the following compound (4) in addition to the above compound (1) or (2).

Si(X⁴)₄ (4)

In the formula, X⁴ represents a hydrolyzable group and is the same group as the above X¹ or X², and its preferred embodiments are also the same. The compound represented by the formula (4) is preferably tetraisocyanatesilane or tetraalkoxysilane.

The water-repellent layer is preferably formed by applying a water-repellent solution comprising a water-repellent agent and a solvent on the surface of the inner layer of the substrate having the inner layer formed thereon, and then removing the solvent. Depending upon e.g. the type of the water-repellent agent, heating may be carried out, as the case requires, after the removal of the solvent.

The solvent in the water-repellent solution may, for example, be a hydrocarbon, an ester, an alcohol or an ether, preferably an ester. Specifically, an acetic acid ester type solvent such as ethyl acetate, n-propyl acetate or n-butyl acetate is preferred, and n-butyl acetate is particularly preferred. Further, to the water-repellent solution, other components may be added as the case requires. As such other components, for example, a catalyst (e.g. an acid such as hydrochloric acid or nitric acid) for the hydrolytic condensation reaction of the water-repellent agent may be mentioned.

As the method of applying the water-repellent solution on the surface of the undercoat layer, the same method as the method of applying the above dispersion liquid (1) on the surface of the substrate may be mentioned, and the preferred method is also the same. Removal of the solvent may be carried out by maintaining the article after applying the water-repellent agent at a temperature of from room temperature to 200° C. for from 10 to 60 minutes.

In a case where the water-repellent agent is a water-repellent agent having a reactivity such as the above compound (1) or (2) or the like, a hydrolytic reaction, a condensation reaction, etc. of such a compound proceeds at the surface of the undercoat layer to form a water-repellent layer which covers substantially the entirety of the surface of the undercoat layer. Depending upon the type of the water-repellent agent, formation of the water-repellent layer may proceed at the same time as the removal of the solvent, and there may be a case where heating is required. In a case where heating is required, heating is preferably carried out at a temperature of from 60 to 200° C. for from 10 to 60 minutes.

The thickness of the water-repellent layer thus formed is from about 0.5 to 10 nm. Further, the water-repellent substrate of the present invention obtained as described above has a concave-convex surface. The average surface roughness (Ra) of the surface is from about 60 to 300 nm, preferably from 60 to 200 nm. The water-repellent layer formed on the surface of the undercoat inner layer is a very thin layer, whereby the three dimensional shape of the water-repellent layer surface reflects the three dimensional shape of the inner layer surface and thus has a similar value.

Further, the pitch of concave-convex on the water-repellent surface of the water-repellent substrate of the present invention is preferably from about 50 to 300 nm. Here, the pitch is a value calculated from a cross-sectional photograph of the water-repellent article photographed by a scanning electron microscope.

The water-repellent agent is bonded at least to the upper surface of the undercoat layer and may be bonded to portions (portions other than the upper surface) such as concaves or spaces in the undercoat layer formed due to the shape of the aggregates (A). In a case where the water-repellent agent is deposited not only on the upper surface of the undercoat layer but also in the concaves or spaces in the undercoat layer, even if the water-repellency on the surface of the water-repellent article is lowered by the abrasion during the use, the water-repellent performance can be maintained by the water-repellent agent present at the portions such as concaves or spaces in the undercoat layer, such being desirable.

The water-repellent substrate of the present invention may have another layer between the undercoat layer and the water-repellent layer. Such another layer may, for example, be a layer (abrasion resistance-improving layer) to cover the surface of the undercoat layer or to penetrate into the spaces in the undercoat layer thereby to increase the hardness of the undercoat layer to improve the abrasion resistance as a whole, or a layer (adhesion-improving layer) to improve the adhesion between the undercoat layer and the water-repellent layer.

The abrasion resistance-improving layer is preferably a layer made of silicon oxide formed from a polysilazane.

The polysilazane is a linear or cyclic compound having a structure represented by —SiR¹₂—NR²—SiR¹₂— (wherein each of R¹ and R² which are independent of each other, is hydrogen or a hydrocarbon group, and a plurality of R¹ may be different from one another). The polysilazane undergoes a reaction with moisture in the atmosphere, whereby the Si—NR²—Si bond will be decomposed to form a Si—O—Si network thereby to form silicon oxide. Such a hydrolytic condensation reaction is accelerated by heat, and usually, the polysilazane is heated and converted to silicon oxide. To accelerate the reaction, a catalyst such as a metal complex catalyst or an amine type catalyst may be used. As compared with silicon oxide formed from an alkoxysilane, the silicon oxide formed from a polysilazane has a dense structure and thus has high mechanical durability or gas barrier property. Here, it is considered that the reaction to form silicon oxide from the polysilazane does not usually proceed completely by heating up to 300° C., and nitrogen remains in the form of a Si—N—Si bond or other bonds in the silicon oxide, and at least partially, silicon oxynitride is formed. The number average molecular weight of the polysilazane is preferably from about 500 to 5,000. The reason is such that when the number average molecular weight is at least 500, the silicon oxide-forming reaction tends to effectively proceed, and on the other hand, when the number average molecular weight is at most 5,000, the number of cross-linked points in the silicon oxide network can be properly maintained, and it is possible to prevent formation of cracks or pinholes in the matrix.

In a case where the above R¹ or R² is a hydrocarbon group, it is preferably an alkyl group having at most 4 carbon atoms such as a methyl group or an ethyl group, or a phenyl group. In a case where R¹ is a hydrocarbon group, such a hydrocarbon group will remain on the silicon atom of silicon oxide to be formed. If the amount of such a hydrocarbon group bonded to the silicon atom increases, the property such as abrasion resistance is likely to deteriorate, and accordingly, the amount of the hydrocarbon group bonded to the silicon atom in the polysilazane is preferably small, and in a case where a polysilazane having a hydrocarbon group bonded to the silicon atom is to be used, it is preferred to use it in combination with a polysilazane having no hydrocarbon group bonded to the silicon atom. As a more preferred polysilazane, a perhydropolysilazane of the above formula wherein R¹═R²═H, a partially organic polysilazane of the formula wherein R¹=a hydrocarbon group and R²═H, or a mixture thereof, is preferably employed. In the polysilazane, the proportion of the number of silicon atoms to which hydrocarbon groups are bonded, is preferably at most 30%, particularly preferably at most 10%, based on all silicon atoms. A layer of silicon oxide formed by using such a polysilazane is very useful since the mechanical strength is high. A particularly preferred polysilazane is a perhydropolysilazane.

Further, by accelerating the curing of the polysilazane, it is possible to improve the abrasion resistance. For this purpose, it is preferred to apply an amine after applying the polysilazane on the upper surface of the undercoat layer. As such an amine, ammonia, methylamine, triethylamine or the like may be used. However, it is not desirable that the amine will finally remain on the water-repellent substrate. Accordingly, methylamine is preferred which is readily volatilized as the boiling point is low.

For the adhesion-improving layer, a silicon compound other than the polysilazane (e.g. a silicon compound having a hydrolyzable group such as an alkoxy group, an isocyanate group or a halogen atom bonded to a silicon atom) is preferred. Specifically, it is preferably a silicon oxide layer formed from at least one silicon compound selected from the group consisting of alkoxysilanes such as a tetraalkoxysilane or its oligomer, and an organotrialkoxysilane or its oligomer; chlorosilanes such as an organotrichlorosilane or its oligomer; and an isocyanatesilane.

The abrasion resistance-improving layer or the adhesion-improving layer may be used alone, or both may be used in combination. In a case where both are used in combination, it is preferred that the undercoat layer, the abrasion resistance-improving layer, the adhesion-improving layer and the water-repellent layer are sequentially formed in this order on the surface of the substrate.

Further, the water-repellent layer, the abrasion resistance-improving layer or the adhesion-improving layer may not necessarily cover the entirety of the surface of the layer located thereunder. That is, so long as the function of each layer is sufficiently obtained, there may be a partial portion where such a layer is not formed.

In the water-repellent substrate of the present invention, the undercoat layer is formed by using aggregates which are each composed of metal oxide fine particles having an average primary particle size of from 10 to 80 nm and which have an average aggregate particle size of from 100 to 1,200 nm, whereby the surface has a large water contact angle, and it is possible to maintain the contact angle in a high state even against abrasion.

The water-repellent substrate of the present invention has a surface with a high water contact angle and is capable of maintaining the contact angle in a high state even against abrasion. Accordingly, it is useful for a window glass for a transport machine (such as an automobile, a train, a ship, an airplane or the like) and is particularly useful for a window glass for an automobile. As a window glass for an automobile, it may be a single plate glass or a laminated glass. In a case where the water-repellent substrate of the present invention is used for a laminated glass, it is preferred to employ a method of laminating the water-repellent substrate produced by the above-described method, an interlayer and another substrate in this order, followed by press bonding.

The water-repellent substrate of the present invention shows an excellent antireflection performance in a wide wavelength region, since the refractive index decreases from the substrate surface towards the film surface by the surface roughness. Accordingly, a larger amount of light can be taken into the interior and it is possible to prevent deposition of a stain on the substrate by the water repellency, whereby it is possible to maintain the light transmittance in a high state. Accordingly, it is useful for a cover glass for a solar cell. As the cover glass for a solar cell, it may be a single plate glass, a laminated glass, a figured glass or a condenser lens glass, and a high transmitting composition having a low iron content or an alkali-free composition having a low alkali content is preferred.

In a case where the water-repellent substrate of the present invention is to be used for a window glass for a transport machine or for a cover for a solar cell, such a substrate is preferably transparent. Specifically, its haze value is preferably at most 10%, more preferably at most 5%, further preferably at most 2%.

### EXAMPLES

Now, the present invention will be described in detail with reference to Examples, but it should be understood that the present invention is by no means restricted to such Examples. Examples 1 to 11 are Working Example of the present invention, and Examples 12 to 15 are Comparative Examples.

### [1] Preparation of Silicic Acid Oligomer Solution

To an ethanol solution of tetraethoxysilane (the solid content concentration calculated as SiO₂ was 5 mass %: 95 g), a 60 mass % nitric acid aqueous solution (5 g) was added and stirred for one hour to subject tetraethoxysilane to a hydrolytic condensation reaction to obtain a silicic acid oligomer solution (solid content concentration: 5 mass %).

### [2] Preparation of Aggregate Dispersion Liquid

### [2-1] Preparation of Aggregate Dispersion Liquid (1)

Using a rotary evaporator, a dispersing medium was removed from a dispersion liquid of silica particles (ST-20, manufactured by Nissan Chemical Industries, Ltd., average primary particle size of silica particles: 15 nm) at 60° C. to obtain powdery silica particles (aggregates of silica particles). Then, into a 200 mL alumina container, the above aggregates of silica particles (2 g), ethanol (98 g) and alumina balls (diameter: 0.5 mm, 10 g) were added and stirred for one hour to obtain an aggregate dispersion liquid 1 (100 g). The solid content concentration of the aggregate dispersion liquid 1 was 2 mass %. The average primary particle size of silica particles in the aggregate dispersion liquid 1 was 15 nm, and the average aggregate particle size of the aggregates was 130 nm.

By removing the dispersing medium from the dispersion liquid of the raw material silica particles, the silica particles formed aggregates, and such aggregates were stirred together with alumina balls to obtain aggregates having a desired average aggregate particle size.

### [2-2] Preparation of Aggregate Dispersion Liquid (2)

An aggregate dispersion liquid 2 was prepared in the same manner as in [2-1] except that aggregates having a mean aggregates particle size of 550 nm were prepared by using a dispersion liquid (ST-50, manufactured by Nissan Chemical Industries, Ltd.) wherein silica particles having an average primary particle size of 25 nm were dispersed.

### [2-3] Preparation of Aggregate Dispersion Liquid (3)

An aggregate dispersion liquid 3 was prepared in the same manner as in [2-1] except that aggregates of silica fine particles having an average aggregate particle size of 920 nm were prepared by using a dispersion liquid (ST-20L, manufactured by Nissan Chemical Industries, Ltd.) wherein silica particles having an average primary particle size of 45 nm were dispersed.

### [2-4] Preparation of Aggregate Dispersion Liquid (4)

An aggregate dispersion liquid 4 was prepared in the same manner as in [2-1] except that aggregates having an average aggregate particle size of 220 nm were prepared by using a dispersion liquid (ST-XL, manufactured by Nissan Chemical Industries, Ltd.) wherein silica particles having an average primary particle size of 50 nm were dispersed.

### [2-5] Preparation of Aggregate Dispersion Liquid (5)

Into a 200 mL quartz pressure resistant container, ethanol (85.3 g), an aqueous dispersion liquid (solid content concentration: 20%) (7.1 g) of particles of zinc oxide (dielectric constant: 18), tetraethoxysilane (solid content concentration calculated as silicon oxide: 28.8 mass %, 6.9 g) and 28 mass % aqueous ammonia (0.6 g) were introduced to prepare a raw material liquid having a pH of 10. The average primary particle size of zinc oxide was 20 nm, the average aggregate particle size was 1,000 nm, and the solid content concentration of the dispersion liquid of the zinc oxide particles was 20 mass %.

After sealing the pressure resistant container, using a microwave heating apparatus with a maximum output power of 1,000 W, the raw material liquid was irradiated for 3 minutes with microwaves with a frequency of 2.45 GHz with such an output power that the raw material liquid was heated to 180° C. By this operation, a dispersion liquid (100 g) of core-shell particles was obtained wherein the core was made of zinc oxide, and the shell was made of silicon oxide.

Such core-shell particles were ones obtained by irradiation with microwaves whereby tetraethoxysilane was hydrolyzed, and a condensation reaction of the hydrolyzate proceeded at the surface of the zinc oxide particles. The solid content concentration of zinc oxide in this dispersion liquid of core-shell particles was 1.4 mass %, and the solid content concentration of silicon oxide was 2 mass %. The shell thickness was 10 nm.

To this dispersion liquid (100 g) of core-shell particles, 100 g of a strongly acidic cation exchange resin (DIAION manufactured by Mitsubishi Chemical Corporation, total exchange capacity: at least 2.0 meq/mL) was added and stirred for two hours, and when the pH became 4, the strongly acidic cation exchange resin was removed by filtration to obtain a dispersion liquid 5 of aggregates of core-shell particles. This dispersion liquid of core-shell particles had an average primary particle size of 30 nm and an average aggregate particle size of 530 nm.

The average aggregate particle size was controlled by the time for stirring with the strongly cation exchange resin. In a case where the shell thickness was 10 nm, the zinc oxide core particles were not dissolved even when the pH became 4.

### [2-6] Preparation of Aggregate Dispersion Liquid (6)

A dispersion liquid of core-shell particles was obtained in the same manner as in [2-5] except that a raw material liquid having a pH of 10 was prepared by introducing an aqueous dispersion liquid (solid content concentration: 20%) (25 g) of particles of zinc oxide (dielectric constant: 18) having an average primary particle size of 20 nm, tetraethoxysilane (solid content concentration calculated as silicon oxide: 28.8 mass %) (6.9 g), ethanol (67.5 g) and 28 mass % aqueous ammonia (0.6 g).

To this dispersion liquid (100 g) of core-shell particles, 100 g of a strongly acidic cation exchange resin (DIAION manufactured by Mitsubishi Chemical Corporation, total exchange capacity: at least 2.0 meq/mL) was added and stirred for 6 hours, and when the pH became 4, the strongly acidic cation exchange resin was removed by filtration to obtain a dispersion liquid 6 of aggregates of hollow particles. The average primary particle size of this dispersion liquid of hollow particles was 30 nm, and the average aggregate particle size was 400 nm. In a case where the shell thickness was 4 nm, when the pH became 4, zinc oxide core particles were dissolved to obtain hollow particles.

### [2-7] Preparation of Aggregate Dispersion Liquid (7)

A dispersion liquid 7 of aggregates of hollow particles was obtained in the same manner as in [2-6] except that after adding the strongly acidic cation exchange resin, stirring was carried out for one hour. The average primary particle size of the hollow particles was 30 nm, the average aggregate particle size was 810 nm, and the shell thickness was 4 nm.

### [2-8] Preparation of Aggregate Dispersion Liquid (8)

A dispersion liquid 8 of aggregates of hollow particles was obtained in the same manner as in [2-6] except that a raw material liquid having a pH of 10 was prepared by introducing an aqueous dispersion liquid (solid content concentration: 20%) (41.7 g) of particles of zinc oxide (dielectric constant: 18) having an average primary particle size of 35 nm, tetraethoxysilane (solid content concentration calculated as silicon oxide: 28.8 mass %) (6.9 g), ethanol (50.8 g) and 28 mass % aqueous ammonia (0.6 g). The average primary particle size of the hollow particles was 45 nm, the average aggregate particle size was 560 nm, and the shell thickness was 4 nm.

### [2-9] Preparation of Aggregate Dispersion Liquid (9)

A dispersion liquid of hollow particles was obtained in the same manner as in [2-6] except that a raw material liquid having a pH of 10 was prepared by introducing an aqueous dispersion liquid (solid content concentration: 20%) (10 g) of particles of zinc oxide (dielectric constant: 18) having an average primary particle size of 20 nm, tetraethoxysilane (solid content concentration calculated as silicon oxide: 28.8 mass %) (6.9 g), ethanol (82.5 g) and 28 mass % aqueous ammonia (0.6 g). The average primary particle size of the hollow particles was 45 nm, the average aggregate particle size was 570 nm, and the shell thickness was 8 nm.

### [2-10] Preparation of Aggregate Dispersion Liquid (10)

A dispersion liquid 10 of aggregates of hollow particles was obtained in the same manner as in [2-6] except that a raw material liquid having a pH of 10 was prepared by introducing an aqueous dispersion liquid (solid content concentration: 20%) (83.3 g) of particles of rod-shaped zinc oxide (dielectric constant: 18) having an average primary particle size of 30 nm in short diameter and 190 nm in long diameter, tetraethoxysilane (solid content concentration calculated as silicon oxide: 28.8 mass %) (6.9 g), ethanol (9.1 g) and 28 mass % aqueous ammonia (0.6 g). The average primary particle size of the hollow particles was 40 nm in short diameter and 200 nm in long diameter, and the average aggregate particle size was 530 nm, and the shell thickness was 4 nm.

### [2-11] Preparation of Aggregate Dispersion Liquid (11)

A dispersion liquid of hollow particles was obtained in the same manner as in [2-6] except that a raw material liquid having a pH of 10 was prepared by introducing an aqueous dispersion liquid (solid content concentration: 20%) (4.7 g) of particles of zinc oxide (dielectric constant: 18) having an average primary particle size of 20 nm, tetraethoxysilane (solid content concentration calculated as silicon oxide: 28.8 mass %) (6.9 g), ethanol (87.8 g) and 28 mass % aqueous ammonia (0.6 g). The average primary particle size of the hollow particles was 50 nm, the average aggregate particle size was 580 nm, and the shell thickness was 12 nm.

### [2-12] Preparation of Aggregate Dispersion Liquid (12)

In a 200 mL beaker, an aqueous dispersion liquid of silica particles having an average primary particle size of 25 nm (solid content concentration: 50%, ST-50 manufactured by Nissan Chemical Industries, Ltd.) (4 g) and ethanol (96 g) were mixed to obtain a dispersion liquid 12 of aggregates having an average aggregate particle size of 30 nm. The solid content concentration of the dispersion liquid 12 of aggregates was 2 mass %.

### [2-13] Preparation of Aggregate Dispersion Liquid (13)

A dispersion liquid 13 of aggregates of hollow particles was obtained in the same manner as in [2-6] except that zinc oxide having an average primary particle size of 20 nm and an average aggregate particle size of 30 nm was used. The average primary particle size of the hollow particles was 30 nm, the average aggregate particle size was 40 nm, and the shell thickness was 4 nm.

### [2-14] Preparation of Aggregate Dispersion Liquid (14)

A dispersion liquid 14 of aggregates of hollow particles was obtained in the same manner as in [2-10] except that zinc oxide having an average primary particle size of 70 nm was used. The average primary particle size of the hollow particles was 90 nm, the average aggregate particle size was 560 nm, and the shell thickness was 4 nm.

### [2-15] Preparation of Aggregate Dispersion Liquid (15)

A dispersion liquid 15 of aggregates of hollow particles was obtained in the same manner as in [2-6] except that after adding the strongly acidic cation exchange resin, the mixture was left to stand still for 6 hours without stirring. The average primary particle size of the hollow particles was 30 nm, the average aggregate particle size was 1,300 nm, and the shell thickness was 4 nm.

### [3] Preparation of Coating Fluid for Undercoat Layer

Into a 200 mL glass container, the silicic acid oligomer solution (16 g) prepared in [1], ethanol (24 g) and each dispersion liquid of aggregates (60 g) prepared in [2] were introduced and stirred for 10 minutes to obtain various coating fluids for undercoat layers. The solid content concentration in each coating fluid was 2 mass %.

A coating fluid for undercoat layer obtained from the dispersion liquid 1 of aggregates prepared in [2] will be referred to as the coating fluid 1 for undercoat layer. Likewise, coating fluids for undercoat layers obtained from dispersion liquids 2 to 15 of aggregates will be referred to as the coating fluids 2 to 15 for undercoat layers, respectively.

### [4] Preparation of Water-Repellent Solution

F(CF₂)₈(CH₂)₂Si(NCO)₃ (0.8 g) was dissolved in n-butyl acetate (160 g) to prepare a water-repellent solution.

### Example 1

On the surface of a glass substrate (100 mm×100 mm, thickness: 3.5 mm) wiped with ethanol, the coating fluid 1 for undercoat layer was dropped and spin-coated (rotational speed: 300 rpm, 60 seconds) to apply the coating fluid 1 for undercoat layer on the surface of the substrate. By heating at 200° C. for 30 minutes, to obtain the substrate provided with an undercoat layer. Then, on the surface of the undercoat layer of the substrate provided with the undercoat layer, the water-repellent solution prepared in [4] was dropped and spin-coated (rotational speed: 300 rpm, 60 seconds), followed by drying at room temperature to prepare a sample 1.

With respect to this sample 1, the average square roughness, the water contact angle (initial and after abrasion test), the initial haze value, the refractive index of aggregates and the average reflectance were measured. The results are shown in Tables. Here, for the abrasion test, using a reciprocating traverse tester (manufactured by KNT), a flannel cloth (cotton No. 300) was reciprocated 100 times on the surface of the water-repellent substrate by exerting a road of 9.8 N/4 cm² on the surface of the water-repellent substrate.

### Examples 2 to 15

Samples 2 to 15 were prepared in the same manner as in Example 1 except that the type of the coating fluid for undercoat layer was changed as shown in the following Tables, and evaluated. Here, Examples 12 and 13 are considered to correspond to Examples wherein the undercoat layer was formed by using primary fine particles, since the difference between the average primary particle size and the average aggregate particle size was small.

TABLE 1

| | Ex. 1 | Ex. 2 | Ex. 3 | Ex. 4 | Ex. 5 |
|---|---|---|---|---|---|
| Coating fluid for | 1 | 2 | 3 | 4 | 5 |
| undercoat layer | | | | | |
| Particles | Solid SiO₂ | Solid SiO₂ | Solid SiO₂ | Solid SiO₂ | Core-shell particles |
| | | | | | (Core: ZnO, |
| | | | | | Shell: SiO₂) |
| Average primary | 15 | 25 | 45 | 50 | 30 |
| particle size (nm) | | | | | |
| Average aggregate | 130 | 550 | 920 | 220 | 530 |
| particle size (nm) | | | | | |
| Shell thickness (nm) | — | — | — | — | 10 |
| Thickness of | 230 | 340 | 650 | 260 | 320 |
| undercoat layer (nm) | | | | | |
| Initial water contact | 138 | 160 | 158 | 155 | 148 |
| angle (°) | | | | | |
| Water contact angle after | 135 | 138 | 136 | 135 | 135 |
| abrasion (°) | | | | | |
| Mean square | 42 | 74 | 79 | 87 | 46 |
| roughness (nm) | | | | | |
| Initial haze value (%) | 2.3 | 3.0 | 4.6 | 2.8 | 8.3 |
| Refractive index of | 1.44 | 1.44 | 1.44 | 1.44 | 1.58 |
| aggregates | | | | | |
| Average reflectance (%) | 2.3 | 2.2 | 2.5 | 2.5 | 4.2 |

TABLE 2

| | Ex. 6 | Ex. 7 | Ex. 8 | Ex. 9 | Ex. 10 |
|---|---|---|---|---|---|
| Coating fluid for | 6 | 7 | 8 | 9 | 10 |
| undercoat layer | | | | | |
| Particles | Hollow SiO₂ | Hollow SiO₂ | Hollow SiO₂ | Hollow SiO₂ | Hollow SiO₂ |
| Average primary | 30 | 30 | 45 | 45 | 40 × 200 |
| particle size (nm) | | | | | |
| Average aggregate | 400 | 810 | 560 | 570 | 530 |
| particle size (nm) | | | | | |
| Shell thickness (nm) | 4 | 4 | 4 | 8 | 4 |
| Thickness of | 320 | 550 | 380 | 390 | 420 |
| undercoat layer (nm) | | | | | |
| Initial water contact | 150 | 161 | 155 | 158 | 159 |
| angle (°) | | | | | |
| Water contact angle after | 138 | 139 | 139 | 137 | 138 |
| abrasion (°) | | | | | |
| Mean square | 35 | 106 | 67 | 58 | 79 |
| roughness (nm) | | | | | |
| Initial haze value (%) | 0.9 | 2.0 | 1.8 | 2.2 | 1.9 |
| Refractive index of | 1.23 | 1.23 | 1.18 | 1.37 | 1.11 |
| aggregates | | | | | |
| Average reflectance (%) | 0.8 | 1.5 | 1.3 | 1.8 | 1.5 |

TABLE 3

| | Ex. 11 | Ex. 12 | Ex. 13 | Ex. 14 | Ex. 15 |
|---|---|---|---|---|---|
| Coating fluid for | 11 | 12 | 13 | 14 | 15 |
| undercoat layer | | | | | |
| Particles | Solid SiO₂ | Hollow SiO₂ | Hollow SiO₂ | Hollow SiO₂ | Hollow SiO₂ |
| Average primary | 50 | 25 | 30 | 90 | 30 |
| particle size (nm) | | | | | |
| Average aggregate | 580 | 30 | 40 | 560 | 1300 |
| particle size (nm) | | | | | |
| Shell thickness (nm) | 13 | — | 4 | 4 | 4 |
| Thickness of | 400 | 280 | 320 | 400 | 960 |
| undercoat layer (nm) | | | | | |
| Initial water contact | 150 | 122 | 125 | 128 | 132 |
| angle (°) | | | | | |
| Water contact angle after | 135 | 115 | 121 | 123 | 120 |
| abrasion (°) | | | | | |
| Mean square | 65 | 18 | 23 | 65 | 96 |
| roughness (nm) | | | | | |
| Initial haze value (%) | 4.8 | 0.1 | 0.2 | 2.2 | 3.2 |
| Refractive index of | 1.41 | 1.44 | 1.23 | 1.11 | 1.23 |
| aggregates | | | | | |
| Average reflectance (%) | 2.3 | 3.5 | 2.3 | 1.9 | 2.3 |

1. Average Primary Particle Size

Particles were observed by a transmission type electron microscope (H-9000 manufactured by Hitachi, Ltd.), whereby 100 particles were randomly selected, the particle sizes of the respective particles were measured, and their averaged value was taken as the average primary particle size.

2. Average Aggregate Particle Size

The average aggregate particle size of particles was measured by using a dynamic light scattering particle size analyzer (MICROTRAC UPA manufactured by NIKKISO CO., LTD).

3. Shell Thickness

Particles were observed by a transmission type electron microscope (H-9000 manufactured by Hitachi, Ltd.), whereby the shell thickness of the particles was measured.

4. Thickness of Undercoat Layer

The cross-section of the substrate having an undercoat layer formed thereon was photographed by a scanning electron microscope (S-4500 model, manufactured by Hitachi, Ltd.), and in the image, the length of a line perpendicular from the substrate surface to an apex of a convex of the undercoat layer was measured. The photograph was taken under such measuring conditions that the accelerating voltage was 1 kV, the emission current was 5 μA, the inclination angles were 0° and 60°, and the observation magnification was 50,000 magnifications.

5. Water Contact Angle

2 μL of a water droplet was dropped on the surface of a water-repellent substrate, and the contact angle of the water droplet was measured by means of a contact angle meter (CA-X¹⁵⁰ model, manufactured by Kyowa Interface Science Co., LTD.).

6. Average Square Roughness

The surface shape of the water-repellent article was measured by means of a probe microscope (Nanopics 1000 manufactured by Seiko Instruments Inc.). For the measurement, the observation mode of the probe microscope was dumping mode, the scanning area was 40 μm, and the scanning speed was 65 sec/frame. The average square roughness was calculated by means of an exclusive software.

7. Haze Value

The haze value of the water-repellent article was measured in accordance with JIS K-7105, by using a haze computer (Model: S-SM-K224, manufactured by Suga Test Instruments Co., Ltd.).

8. Refractive Index of Aggregates

For the refractive index of aggregates, the reflectance at from 300 nm to 1,200 nm of the film on the substrate was measured by a spectrophotometer (model: U-4100 manufactured by Hitachi, Ltd.), and from the obtained lowest reflectance, the refractive index of the film on the substrate was calculated and converted by the weight ratio of the particles to the binder.

9. Average Reflectance

The reflectances at from 300 nm to 1,200 nm of the film on the water-repellent substrate were measured by a spectrophotometer (model: U-4100 manufactured by Hitachi, Ltd.), and their average value was taken as an average reflectance.

### INDUSTRIAL APPLICABILITY

The water-repellent substrate of the present invention has a surface having a large water contact angle and is excellent in abrasion resistance and antireflection performance, and thus, it is useful for a window glass for a transport machine (such as an automobile, a train, a ship or an airplane) or a cover for a solar cell.

The entire disclosure of Japanese Patent Application No. 2008-186148 filed on Jul. 17, 2008 including specification, claims, drawings and summary is incorporated herein by reference in its entirety.

What is claimed is:

1. A process for producing a water-repellent substrate, characterized by forming, on at least one side of a substrate, an undercoat layer which comprises the following aggregates (A) of metal oxide fine particles and a metal oxide type binder (provided that the metal oxide type binder is a component formed from a binder material containing a metal compound (B) which can be converted to a metal oxide by hydrolytic condensation or pyrolysis) and which has a concave-convex surface, and then, forming a water-repellent layer on the undercoat layer:
Aggregates (A) of metal oxide fine particles: aggregates which are each composed of metal oxide fine particles having an average primary particle size of from 10 to 80 nm and which have an average aggregate particle size of from 100 to 1200 nm.

2. The process for producing a water-repellent substrate according to claim 1, wherein the undercoat layer is formed by applying, on at least one side of the substrate, a dispersion liquid which comprises the aggregates (A) of metal oxide fine particles, the binder material and a dispersing medium, followed by drying.

3. The process for producing a water-repellent substrate according to claim 1, wherein the undercoat layer has a thickness of from 100 to 1500 nm.

4. The process for producing a water-repellent substrate according to claim 2, wherein the concentration of the aggregates (A) of metal oxide fine particles contained in the dispersion liquid is from 0.1 to 5 mass % based on the dispersion liquid.

5. The process for producing a water-repellent substrate according to claim 1, wherein the aggregates (A) of metal oxide fine particles are aggregates of fine particles containing at least one metal oxide selected from the group consisting of SiO₂, Al₂O₃, TiO₂, SnO₂, ZrO₂ and CeO₂.

6. The process for producing a water-repellent substrate according to claim 1, wherein the aggregates (A) of metal oxide fine particles are aggregates of metal oxide fine particles having a refractive index of at most 1.4.

7. The process for producing a water-repellent substrate according to claim 1, wherein the initial water contact angle is at least 135°.

8. The process for producing a water-repellent substrate according to claim 1, wherein the aggregates (A) of metal oxide fine particles are aggregates of hollow metal oxide fine particles.

9. The process for producing a water-repellent substrate according to claim 8, wherein the aggregates of hollow metal oxide fine particles are aggregates of hollow SiO₂ fine particles.

10. The process for producing a water-repellent substrate according to claim 8, wherein the hollow metal oxide fine particles have a shell thickness of from 1 to 10 nm.

11. The process for producing a water-repellent substrate according to claim 9, wherein the aggregates of hollow SiO₂ fine particles are obtained in the form of a dispersion liquid having aggregates of hollow SiO₂ fine particles dispersed in a dispersing medium by carrying out at least the following steps (a) to (c):
(a) a step of reacting a precursor for SiO₂ at pH>8 in the presence of ZnO fine particles to constitute cores in a dispersing medium, to form SiO₂ thereby to obtain a dispersion liquid of fine particles having the ZnO fine particles covered with the formed SiO₂,
(b) a step of mixing and contacting the dispersion liquid of fine particles obtained in step (a) with an acidic cation exchange resin to dissolve the core-constituting ZnO fine particles in a range of pH=2 to 8, and
(c) a step of separating, after the ZnO fine particles have been completely dissolved, the cation exchange resin by solid-liquid separation thereby to obtain the dispersion liquid of hollow SiO₂ fine particles.

12. The process for producing a water-repellent substrate according to claim 11, wherein in the step (a), under irradiation with microwaves, the precursor for SiO₂ is reacted at pH>8 to form SiO₂ thereby to cover the ZnO fine particles with the formed SiO₂.

13. A water-repellent substrate, characterized by having, on at least one side of a substrate, an undercoat layer which comprises the following aggregates (A) of metal oxide fine particles and a metal oxide type binder (provided that the metal oxide type binder is a component formed from a binder material containing a metal compound (B) which can be converted to a metal oxide by hydrolytic condensation or pyrolysis) and which has a concave-convex surface, and having a water-repellent layer on the undercoat layer:
Aggregates (A) of metal oxide fine particles: aggregates which are each composed of metal oxide fine particles having an average primary particle size of from 10 to 80 nm and which have an average aggregate particle size of from 100 to 1200 nm.

14. A water-repellent substrate, characterized in that it is obtained by applying, on at least one side of a substrate, a dispersion liquid which comprises the following aggregates (A) of metal oxide fine particles, a binder material containing a metal compound (B) which can be converted to a metal oxide by hydrolytic condensation or pyrolysis and a dispersing medium, followed by drying, to form an undercoat layer which has a concave-convex surface, and then, applying a hydrophobic material on the undercoat layer, followed by drying:
Aggregates (A) of metal oxide fine particles: aggregates which are each composed of metal oxide fine particles having an average primary particle size of from 10 to 80 nm and which have an average aggregate particle size of from 100 to 1200 nm.

15. The water-repellent substrate according to claim 13, wherein the water-repellent substrate is a glass plate for a vehicle window or a cover for a solar cell.

16. The water-repellent substrate according to claim 14, wherein the water-repellent substrate is a glass plate for a vehicle window or a cover for a solar cell.
